(19) United States
(12) Patent Application Publication
(10) Pub. No.: US 2018/0375847 A1
(43) Pub. Date: Dec. 27, 2018

(54) STORED VALUE USER IDENTIFICATION SYSTEM USING BLOCKCHAIN OR MATH-BASED FUNCTION

(71) Applicant: ANCHORID, INC, Kingston, NY (US)

(72) Inventor: DAVID W. SCHROPFER, Bearsville, NY (US)

(21) Appl. No.: 16/009,391

(22) Filed: Jun. 15, 2018

Related U.S. Application Data
(60) Provisional application No. 62/523,049, filed on Jun. 21, 2017.

(51) Int. Cl. H04L 29/06; H04L 9/32

(52) U.S. Cl. CPC H04L 63/08; H04L 2209/38; H04L 2463/082; H04L 9/321

(57) ABSTRACT

Systems and methods for creating a numeric value for a present certainty of a user's identity, recording and ‘storing’ that numeric value on a distributed ledger system (including but not limited to blockchain), automatically modifying the numeric value using math-based assets (including but not limited to algorithms) and allowing multiple computer systems to debit the numeric value as part of an authentication or other process.

### BACKGROUND OF THE INVENTION

### 1. Field of the Invention

The present invention relates to an electronic ledger system and more particularly to a stored value user identification system for crediting and debiting the ledger verifying that a user is authenticated accurately.

### 2. Description of Prior Art Including Information Disclosed Under 37 CFR 1.97 and 1.98

Humans use computers and computer networks for a wide variety of reasons. When a human uses a computer, we call that human a “User”. When a user needs to access information on a computer network, that user needs to commonly complete an authentication process to ensure that the user has permission and/or authorization to gain access to the information and other assets available on the computer or computer network. This process is called “authentication.”

Authentication is commonly executed using a system that includes a username and password, commonly referred to as Password Authentication. But, Password Authentication is not the only type of Authentication available, nor is it the most secure type of authentication.

When the user provides a username and password credentials to access an account, there is typically a time limit or token lifetime of how long the account can continually be active before the person needs to again enter a username and password to reassert their credentials. In other words, password credentials entered correctly will give the user access for predetermined and limited amount of time. In this example, when the user name and password is entered correctly, that user has an acceptable “Authentication value” during the number of minutes or hours that they are permitted to continually remain active in the account without being required to re-enter the username or password credentials. This invention expands on that idea: a user can retain the benefit of successfully presenting credentials which are valid for a period of time.

For another example: suppose an authentication system had two values for a user: zero, and one. To log into the website www.example.com, a value of zero is unacceptable for access, but a value of one is acceptable for access. When the user first attempts to access their account, the system sees that the value is zero, and therefore requests a username and password. Let's assume this particular account can remain continuously open for three hours without the need to re-enter a username and password. In this example, the authentication value would be reset to zero after the third hour has passed, and the user would be challenged to login again. This is an example of a value (instead of just a credential) used to determine if the user may gain access or not.

Stored Value systems are concept not commonly associated with Authentication. The concept of a ‘stored value’ is common in the areas of payments and credit cards and used in many applications. For example, a prepaid credit card has an initial value of zero, and is later loaded with a specific value based on funds or other credits paid into the “stored value” card, and then those funds can be used for purchases wherever that prepaid credit card is accepted until the entire stored value of card is exhausted or reloaded with additional value. This is the basic premise for ‘stored value’ authentication.

In addition to the concepts of Authentication and Stored Value, new technologies like distributed ledgers, and other math-based systems (including, but not limited to blockchain) present an opportunity to change the nature and process of authentication systems with new processes and new security methods. As an example of a distributed ledger, a blockchain has been used successfully create both security and verifiability of a given account balance. To achieve a verifiable account balance, the data in a blockchain is duplicated on many, sometimes thousands of computer systems in multiple geographic locations. To achieve security, each transaction, or small group of transactions

The present invention provides new authentication systems, processes and programs that combine elements of traditional authentication, stored value systems, and distributed ledgers like blockchain.

### BRIEF SUMMARY OF THE INVENTION

It is a prime object of the present invention to provide a stored value user identification system using blockchain or mathematics based function.

It is another object of the present invention to provide a stored value user identification system using blockchain or mathematics based function in which a user can retain the benefit of successfully presenting credentials for a period of time.

It is another object of the present invention to provide a user identification system using blockchain or mathematics based function which is based upon “stored value” authentication.

It is another object of the present invention to provide a stored value user identification system in which distributed ledgers, and other math-based systems (including, but not limited to blockchain), are used for storage.

It is another object of the present invention to provide a stored value user identification system using blockchain or mathematics based function in which new authentication systems, processes and programs that combine elements of traditional authentication, stored value and distributed ledgers like blockchain are utilized.

In general, the above noted objects are achieved by the present invention which relates to systems for creating a numeric value for the present certainty of a user's identity. The numerical value is recorded and ‘stored’ on a distributed ledger (including but not limited to blockchain). The numeric value is automatically modified using math-based assets (including but not limited to algorithms). The system allows multiple computer systems to debit the numeric value as part of an authentication or other process.

In accordance with one aspect of the present invention, a stored value user identification system is provided wherein a Stored Value Identifier (SVID) is established by a Trusted Entity. Once the SVID is established, an electronic account requiring access authorization is associated with the SVID such that the electronic account will recognize the SVID as a valid credential. When a User enters one or more authentication factors into the system, the system recognizes the User's valid SVID. The Trusted Entity then sends details of the authorization factors to a mathematical processor. The processor assigns a quantity of SVID Units (illustrated in FIG. 2, Numeral 6) for the authorization factors. The assigned quantity of SVID Units is entered into the User's account which changes the SVID Balance. The “Balance” of an SVID is based on the quantity of units assigned to a given SVID. A unit of SVID is like a currency, and can be credited or debited like a currency, and traded like a currency. The SVID Balance is debited based upon predetermined variables or the use of User's SVID to authenticate the User on the system.

The User account is maintained on a ledger. The ledger may be present on blockchain.

The predetermined variables may include the passage of time.

The electronic account may include any account used to access a computer, a computer network or computer software. The electronic account may include an authentication directory configured to recognize the SVID as a valid credential.

The authentication factors may include different types of authentication factor(s) and may, for example, be selected from the following group: PIN number, geolocation, biometrics, tokens, period of continuous use of the system by User, number of failed authentication attempts over a given time period.

The quantity of SVID Units may be based upon User activity.

The quantity of SVID Units may be based upon the factor(s) of authentication.

The quantity of SVID Units may be a function of the strength of the factor(s) of authentication. The SVID Balance increases as the strength of factors of authentication increase.

The SVID Balance may be adjusted by an algorithm. For example, the algorithm may debit the balance of the SVID based upon the one or more of the following factors: the time the User is using a SVID, the number of times the User uses the SVID to authenticate the user, and the number of times authentication attempts are unsuccessful.

The distribution of credits to different users may be uneven. The uneven distribution may, for example, be due to one or more of the following factors: length of time User has been an account holder, frequency of use of the system, lack of negative incidents, rejected authorization attempts, fraud, and suspicious use.

The system allows a User to gain elevated status leading to increased SVID credits. For example, the elevated status may be earned by one or more of the following: longevity of use, frequency of use, and lack of negative incidents.

The system allows for multiple factors of authentication in a single event. The authentication may be available through a single portal. Different factors of authentication may be used for registration, recovery and authentication. Different factors of authentication may generate different quantities of SVID units.

The SVID may be shared among different applications and systems in the same enterprise network, or cloud network which is an extension of an enterprise network.

The SVID Balance may increase by multiple units depending upon the authentication factor. The multiple factors may be used for a single authorization.

The SVID Balances may decrease based upon multiple elements.

The system allows only Trusted Entities to credit a user's authentication value.

In accordance with another aspect of the present invention, a method of stored value user identification is provided including the following steps: establishing a SVID by a Trusted Entity; associating an electronic account requiring access authorization with the SVID such that the electronic account will recognize the SVID as a valid credential, recognizing the User's valid SVID when the User enters an authorization factor into the system;

the Trusted Entity sending details of the authorization factor to a mathematical processor; processor assigns a single quantity of SVID Units for the authorization factor; entering the assigned quantity of SVID Units into the User account, and debiting the quantity of SVID Units in User account based upon predetermined variables or use of User's SVID to authenticate User on the system.

### BRIEF DESCRIPTION OF THE SEVERAL VIEWS OF DRAWINGS

To these and to such other objects that may hereinafter appears, the present invention relates to a stored value user identification system using blockchain or math-based function as described in detail in the following specification and recited in the annexed claims, taken together with the accompanying drawings, in which like numerals refer to like parts and in which:

FIG. 1 is a flow chart of the functions and ledger entries of the present invention;

FIG. 2 is an example of possible blockchain entries; and

FIG. 3 is an example of a possible multifactor authentication marketplace.

### DETAILED DESCRIPTION OF THE INVENTION

This invention encompasses the entire process by which a living person (“User”) can safely establish their identity, and simultaneously produce a corresponding value for that identity based on exactly how that identity was established and reinforced. For purposes of this application, the phrases “Stored Value Identity,” or “Stored Value Identifier,” or “Stored Value ID,” or “SVID” are used to refer to an electronic ledger which tracks credits (increases to the value) and debits (deductions from the value) for a User's SVID.

Only an entity that has been approved by the system administrator or other governing body of the SVID system (a “Trusted Entity”) can apply credits to an SVID. Credits can be made by a single Trusted Entity, or multiple Trusted Entities. Each entity capable of crediting an account would need to be licensed or otherwise accredited as an entity that can be trusted, such as a bank, an insurance company, or a software company set up for that purpose.

A critical element of the present invention is that all parties that credit an SVID be trusted by a central entity such as a system administrator, or by a standard set by a government or community (the “Governing Body”). The standards set by the Governing Body will be based on criterion such as security practices, security certifications, history of fraud, history of system breaches by bad actors, history of compliance with data security laws, history of compliance with privacy laws, etc. This practice will avoid SVID's being credited by an unscrupulous, or fraudulent entity. The Governing Body can decide to limit the total number of SVID's available in a given market at a given time, and sell or trade SVIDs for other currencies.

Once established, a Trusted Entity may have a limited number of units of SVID's credited to its account. These units of SVID's will represent the sum of the units that the Trusted Entity has available to credit or debit other accounts. This number of SVID's can be adjusted automatically due to the passage of time, negative incidents related to Trusted Entity, or lack of incidents related to the Trusted Entity. SVIDs can be traded for other currency by Trusted entities and other entities.

The SVID Balance, or the number of units credited or debited based on User activity, is determined by how the user authenticates himself or herself. There are many different factors of authentication that a person can use; some factors are more accurate than others, and thus produce a SVID with a higher score. For example, a weaker factor of authentication such as a 4-digit personal identification number (PIN) will result in a smaller credit to the SVID. However, a stronger factor (or multiple factors) of authentication, such as a combination of biometrics, geolocation, and a cryptographic token used together, would result in a larger credit to the SVID.

All entities, enterprises, or computer systems that either accept an SVID for authentication, or are able to credit an SVID, must be vetted and included in a “white list” or approved list (the “Authorized Entities”) by the system administrator. All Authorized Entities, Trusted Entities, Users, and other entities can trade SVIDs for other SVIDs or other currencies.

A system algorithm is utilized to generate debits to the SVID. Debits can be generated for multiple reasons, including:
Time. As time passes after an authentication event, the SVID can be decreased manually or automatically, such as via an algorithm. For example, if a user logs in to a website using a SVID, one minute later the SVID would be the same as it was the minute before. One hour later, however, the SVID could be reduced by a certain value or percentage; and eight hours later, the SVID would be reduced by a greater value or percentage.
Use. Each time an SVID is used to authenticate the user, the SVID would be reduced by an amount determined manually, individually by each Authorized Entity that accepts the SVID, and/or by algorithm.
Errors. If an authentication attempt is not completed correctly, an error may occur. Multiple errors may indicate in attempt by an unauthorized person to use the system for access. Therefore, multiple errors could also result in additional debits to an SVID. Conversely, the longer the user continuously avoids errors, the fewer debits would occur.
Uneven distribution of credits. Several elements can potentially provide unequal credits for the same activity, such as two users who perform the exact same authentication, but one user gets two credits, and the other gets three credits. These elements include but are not limited to:
Longevity. A user that has been an account holder for a long period of time may be able to earn more credits for the same activity than a user that has been an account holder for a short period of time based on an algorithm or manual process.
Continuous use. A user that has continuously used the system at least once per time interval (for example: a day or a week) for long period of time may be able to earn more credits for the same activity than a user that does not use the system at least once per time interval based on an algorithm or manual process.
Lack of Negative Incidents. A rejected authentication attempt, a case of fraud, and a case of suspicious use are all examples of ‘Negative Incidents.’ These negative incidents could be an indication of an attacker attempting to exploit a valid user account.
Gamification. Users like to earn elevated status. Multiple examples exist in the marketplace, including eBay (which elevates user status based on longevity and continuous use) and foursquare (which elevates status based on number of visits to a physical location.) In the case of cybersecurity and user authentication, an elevated status could actually have value because account history (for example, longevity and continues use, and lack of negative incidents) may indicate a stable, authentic user which may justify additional credits for their activity compared to their counterparts with less longevity and continuity.
A Marketplace for Biometrics and Multiple Factors of Authentication. Multiple traditional and non-traditional factors of authentication are available through a single portal.
Each different factor can be used for three different types of identity and access management: Registration (for example: first-time users) Recovery (for example: lost username or new smartphone), and Authentication (for example: logging in to an app or mobile web.)
Each different factor will generate a different quantity of SVID units.

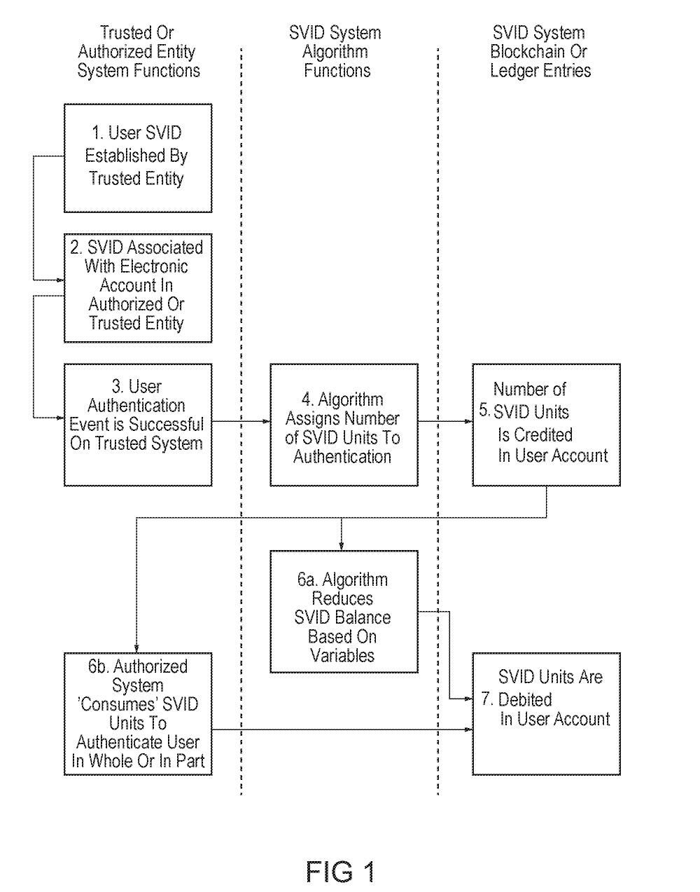

Now referring to the drawings, FIG. 1 is a flow chart of the system and method of the present invention showing trusted or authorized entity system functions, SVID system algorithm functions and SVID System blockchain or ledger entries.

As illustrated in FIG. 1, a Trusted Entity creates a Stored Value Identifier (SVID) through a registration process in Step 1. A ledger entry is not made at this stage because the SVID is not yet associated with an electronic account. An electronic account could include any account that is used to access a computer, computer network, and/or computer software, network software, software as a service, or any other type of account that requires authorization (an ‘Electronic Account’).

In Step 2, the SVID is associated with an Electronic Account so that the authorization directory of the Electronic Account will recognize the SVID as a valid credential.

The first time that the User attempts to access the Electronic Account, the Trusted Entity will require the User to complete one or more processes to complete the authorization. These processes can include, validation of user-provided data and/or mobile phone user data through mobile network operator, credit bureaus, and other third party sources.

If the authentication succeeds, the Trusted Entity sends the details of the authentication event, including the type of authentication factor(s) used (example: PIN number, geolocation, biometrics, tokens, etc.), plus other information (example: number of months of continuous use by the User, Number of Failed authentication attempts in the last three months, etc.) to the processor. In step 4, the processor uses an algorithm or other mathematical formula to assign a value to the authentication. If the authorization fails, the process does not continue, and the user is denied access.

The mathematic process (including but not limited to an algorithm) accepts as an input the information supplied by the Trusted Entity in Step 3 and produces the output of a single numeric value for the authentication at Step 4.

The numeric value generated by the processor in Step 4 is entered into the ledger (including but not limited to Blockchain) at Step 5. The ledger information entered also includes the currency type (in this case, the SVID), an identifier representing the Trusted Entity, an identifier representing the User, and other information.

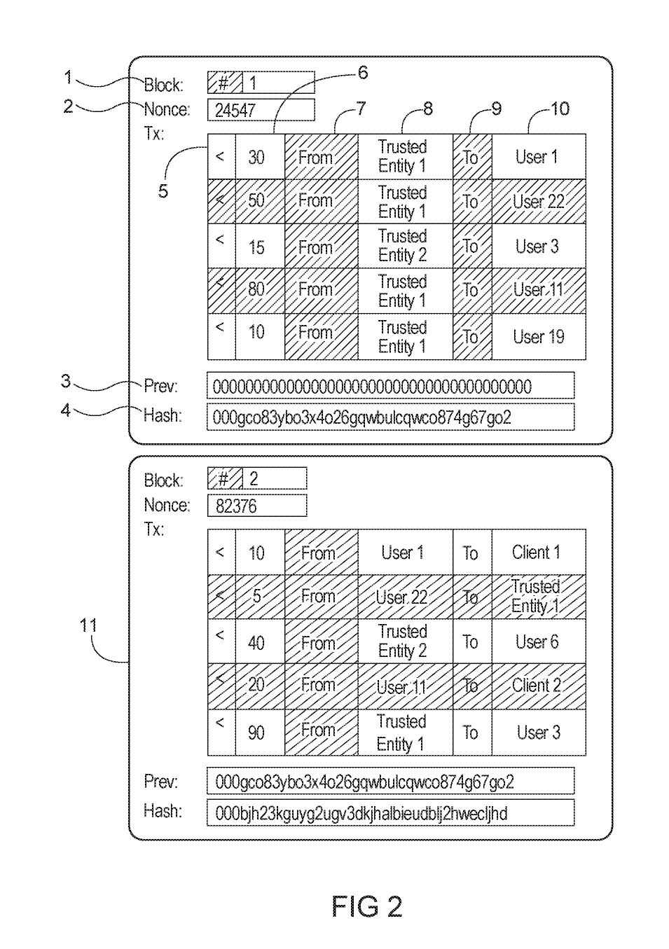

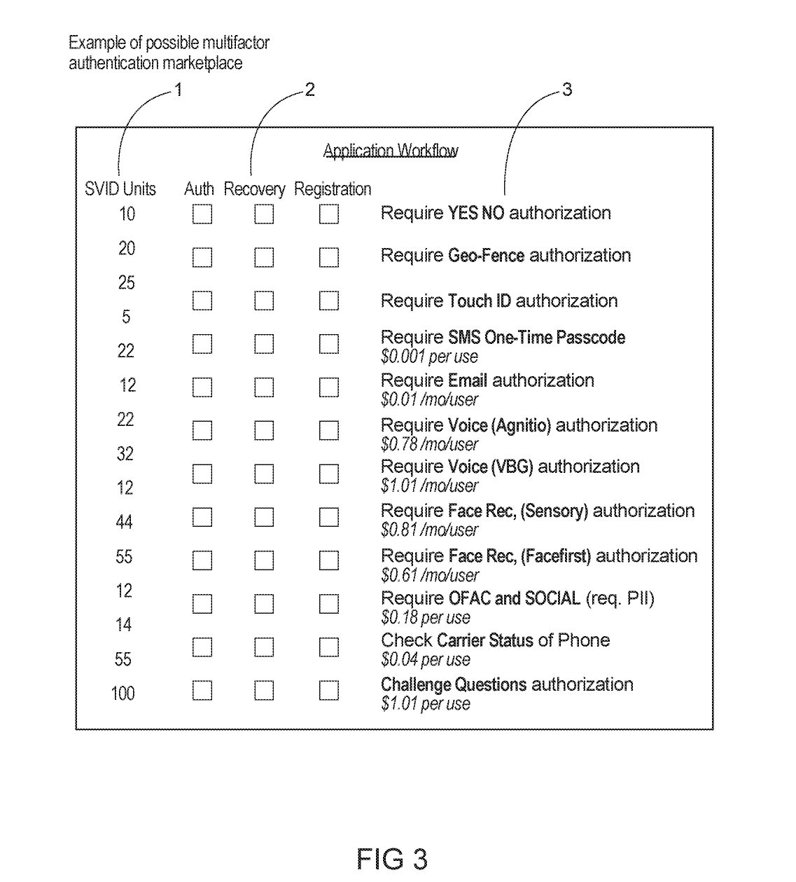

At this point in the flow chart, now that a ledger entry has been made for the User's SVID, either one of two operations could happen next. Either the system algorithm will debit the SVID based on the passage of time or other factors (in Step 6a), or the User will use their SVID to authenticate themselves in whole or in part on an Authorized System (in Step 6b). In either case Step 6a or Step 6b, the ledger is debited by the value generated by the process in Step 6a or in Step 6b. In Step 6a, the algorithm reduces SVID based upon variables, as is illustrated in FIG. 2. In Step 6b, the authorized system “consumes” stored value to authenticate User in whole or in part, as is illustrated in FIG. 3.

In FIG. 2, numerals 1 thru 4 refer to standard terms used in conventional systems to govern the function of a distributed ledger or blockchain. The terms are defined as follows:
Numeral 1: Block—is a packet or package of data that carries recorded data on the blockchain network.
Numeral 2: Nonce—is an arbitrary number that can be used just once. Usually a random number issued in an authentication protocol or blockchain to ensure that old communications cannot be reused.
Numeral 3: Prev—indicates the previous hash, or cryptographic key, produced by processing the contents of the ledger prior to the addition of the current transaction(s). Note that information in Numeral 3 is all zeros, which is a condition only present in the first ‘block’ in the ‘chain’ of blocks of a ledger or a distributed ledger. In the second block in the chain, shown as Numeral 11, the “Prev” value matches the “Hash” value of the previous block, which is a function of blockchain.
Numeral 4: Hash—refers to a cryptographic key produced by processing the contents of the ledger including the current transaction(s).
Numeral 5: Currency symbol. This symbol indicated the type of currency being recorded in the ledger. In this example, the symbol “<” is used to indicate an SVID.
Numeral 6: Quantity of SVID Units. This indicates value of the credit or debit being applied to the SVID in this ledger entry.
Numeral 7: This indicates the value that is being sent from the Name of Sender in item 8, below.
Numeral 8: Name of “Sender”—the name of the entity whose account is debited as a result of the transaction indicated in #6.
Numeral 9: Indicates the value being sent to the Name of Receiver in item 10, below.
Numeral 10: Name of Receiver: Indicates the entity receiving the value indicated in #6, above.

FIG. 3, illustrates an example of possible multifactor authentication factors. Numeral 1 denotes examples of an Quantity of SVID Units for each factor. Numeral 2 shows checkboxes indicating the authentication type used by the Trusted Entity for Authentication, Registration, or Account Recovery. Numeral 3 provides the name of the Authentication Factor.

The present invention is an improvement on conventional systems in several important ways:
The SVID can be shared among different applications and systems in the same enterprise network. This will dramatically reduce the need for expensive single sign-on systems, which traditionally allow a user to sign in to one application successfully, and a single sign-on system gives that user instant access to all other applications on the same system. The reason that single sign-on is expensive is because the authentication mechanism of each individual application in the enterprise system needs to be modified to work off of a single repository of credentials. Given that different applications have vastly different methods of both education and user access, no to single sign-on implementations are exactly alike because of the highly customized nature of the process in any given enterprise system. However, by allowing one Application to receive the authentication score of a given time could allow the user access to additional systems without additional action required by the user, and without the need for the expensive single sign-on system.
Authentication ‘Scores’ or ‘Values’ can be higher than simply “zero” and “one.” For example, if a biometric product, such as voice authentication, was used to authenticate the user on a given application, the user's stored value could increase by 100 units of SVID. Or, if geolocation is used to authenticate the user, the user score could increase to 20 units of SVID, indicating that geolocation is a valuable form of authentication, but not as valuable as a successful voice authentication. In addition, if multiple factors of authentication are used, for example voice authentication, and geolocation, then that could produce a score of 200 units of SVID, making the value of two factors use for single authentication more valuable than the sum of two factors individually.
Multiple elements could “debit” the authentication value, such as time, number of authentication attempts, failed authentication attempts, lifespan of the user account (a person who is been using this system for 10 years successfully should have earned a higher degree of trust and then a user there's been using the system for 10 days.)
Only Trusted entities could “credit” a user's authentication value.

System Delivery: a blockchain could be used for accounting and delivery of the credits and debits. A client or enterprise could become a blockchain miner to accept an SVID. The business model could include each minor paying a subscription or licensing fee to have access to the SVID system.

System Operations: There could be several computers and computer systems involved in the SVID transaction. The order in which each computer is used to successfully transmit the score is important. In the present invention, each computer (including but not limited to the SVID host (for example: the System Administrator), the blockchain miner, and the computing device or personal device belonging to the person who want to authenticate themselves on the blockchain miner's website. The process requires that each computer device communicate with each other computer device in a prescribed order.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims:

I claim:

1. A stored value user identification system wherein a Stored Value Identifier (SVID) account is established for a User by a Trusted Entity, an electronic account requiring access authorization is associated with the SVID such that the electronic account will recognize the SVID as a valid credential, wherein when the User enters an authorization factor into the system, the system recognizes the User's valid SVID and the Trusted Entity sends details of the authorization factor or factors to a mathematical processor which assigns a single numeric value for the quantity of SVID units that represent the authorization factor or factors, the assigned numeric value is credited into the User's SVID account, and the numeric value in User's SVID account is debited based upon predetermined variables or use of User's SVID to authenticate User on the system, and the sum of credits and debits to a User's SVID account at any point in time is the User's SVID Balance.

2. The system of claim 1 wherein the User's SVID Balance is maintained on a ledger.

3. The system of claim 2 wherein the ledger is on blockchain.

4. The system of claim 1 wherein the predetermined variables comprise the passage of time.

5. The system of claim 1 wherein the electronic account comprises any account used to access a computer, a computer network, computer service, or computer software.

6. The system of claim 1 wherein the electronic account comprises an authentication directory configured to recognize the SVID as a valid credential.

7. The system of claim 1 wherein the authentication factor may comprises different types of authentication factor(s).

8. The system of claim 7 wherein the authentication factor(s) are selected from the following group: PIN number, geolocation, biometrics, tokens, period of continuous use of the system by User, number of failed authentication attempts over a given time period.

9. The system of claim 1 wherein the quantity of SVID Units is based upon User activity.

10. The system of claim 1 wherein the quantity of SVID Units is based upon the factor(s) of authentication.

11. The system of claim 1 wherein the quantity of SVID Units is a function of the strength of the factor(s) of authentication.

12. The system of claim 10 wherein the quantity of SVID Units increases as the strength of the factor(s) of authentication increase.

13. The system of claim 1 wherein the numeric value is determined by an algorithm.

14. The system of claim 13 wherein the algorithm may debit the numeric value based upon the one or more of the following factors: the time the User is using a SVID, the number of times the User uses the SVID to authenticate the User, and the number of times that authentication attempts are unsuccessful.

15. The system of claim 1 wherein distribution of credits to different users may be uneven due to one or more of the following factors: length of time User has been an accountholder, frequency of use of the system and lack of negative incidents, rejected authorization attempts, fraud, and suspicious use.

16. The system of claim 1 wherein a User may gain elevated status leading to increased SVID credits.

17. The system of claim 16 wherein elevated status may be earned by one or more of the following: longevity, frequency of use and lack of negative incidents.

18. The system of claim 1 wherein multiple factors of authentication are available.

19. The system of claim 18 wherein multiple factors of authentication are available through a single portal.

20. The system of claim 18 wherein different factors of authentication may be used for registration, recovery and authentication.

21. The system of claim 18 wherein different factors of authentication may generate different quantities of SVID units.

22. The system of claim 1 wherein the SVID can be shared among different applications and systems in the same enterprise network or other enterprise networks.

23. The system of claim 1 wherein SVID Balances may increase by multiple units depending upon the authentication factor.

24. The system of claim 1 wherein multiple factors may be used for a single authorization or authentication.

25. The system of claim 1 wherein SVID Balances may decrease based upon multiple elements.

26. The system of claim 1 wherein only Trusted Entities can credit a user's authentication value.

27. A method of stored value user identification comprising the following steps:
(a) establishing a Stored Value Identifier (SVID) by a Trusted Entity;
(b) associating an electronic account requiring access authorization with the SVID such that the electronic account will recognize the SVID as a valid credential,
(c) recognizing the User's valid SVID when the User enters an authorization factor into the system;
(d) the Trusted Entity sending details of the authorization factor to a mathematical processor;
(e) processor assigns a single numeric value for the authorization factor;
(f) entering the assigned numeric value into the User account, and
(g) debiting the numeric value in User account based upon predetermined variables or use of User's SVID to authenticate User on the system.
